(19) United States
(12) Patent Application Publication
(10) Pub. No.: US 2010/0319804 A1
(43) Pub. Date: Dec. 23, 2010

(54) DEVICE FOR FILLING AND DISTRIBUTING GAS AND ASSEMBLY COMPRISING SUCH A DEVICE

(75) Inventors: Alessandro Moretti, Brescia (IT); Philippe Pisot, L'Isle Adam (FR); Arnaud Denis, Lainville en Vexin (FR); Gervais Lemesle, Pontoise (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L 'Exploitation Des Procedes Georges Claude, Paris (FR)

(21) Appl. No.: 12/864,960

(22) PCT Filed: Jan. 28, 2009
(86) PCT No.: PCT/FR09/50123

§ 371 Date: Jul. 28, 2010

(30) Foreign Application Priority Data
Jan. 30, 2008 (FR) 0850554

(51) Int. Cl. B65B 3/04; F17C 13/00

(52) U.S. Cl. 141/1; 141/192

(57) ABSTRACT

Device for filling and distributing gas comprising a body intended to be placed in the orifice of a pressurized-gas storage reservoir, a gas withdrawing circuit running between an upstream first end intended to be connected to the inside of the reservoir and a downstream second end intended to be connected to a user of the gas, the withdrawing circuit comprising a pressure regulator, a low-pressure chamber and an isolation valve positioned in series in that order from upstream to downstream, the low-pressure chamber being connected to a passage for discharging the gas to the outside of the device via a safety relief valve sensitive to the pressure in the low-pressure chamber and designed to close off the discharge passage when the pressure in the low-pressure chamber is below a first threshold, to open the discharge passage when the pressure in the chamber is higher than the first pressure threshold and below a second pressure threshold, and to close the discharge passage when the pressure in the chamber is higher than the second pressure threshold.

The present invention relates to a gas filling and distributing device, to an assembly comprising a reservoir and such a device, and to a method of controlling leaks.

The invention relates more specifically to a gas filling and dispensing device comprising a body intended to be placed in the orifice of a pressurized gas storage reservoir, a withdrawing circuit running between an upstream first end intended to be connected to the inside of the reservoir and a downstream second end intended to be connected to a user of the gas, the withdrawing circuit comprising a pressure regulator, a low-pressure chamber and an isolating valve all arranged in series in that order from the upstream to downstream end, the low-pressure chamber being connected to a passage for discharging the gas to the outside of the device via a safety relief valve sensitive to the pressure in the low-pressure chamber.

For safety reasons in particular, gas filling and distributing systems such as valves with in-built regulators are provided so that the end-user of a pressurized-gas cylinder cannot come into contact with the gas at the high-pressure of the cylinder, but can rather come into contact only with gas at a pressure that has been reduced by a pressure regulator.

If a valve is positioned downstream of the regulator (on the low-pressure side), an increase in pressure may occur between the regulator and the isolating valve, particularly if the regulator leaks. Specifically, no regulator can be considered to be 100% fluidtight especially in respect of gases the molecules of which are small (of the hydrogen or helium type).

Thus, in the event of long-term storage without any withdrawal of gas, the low-pressure chamber downstream of the regulator may fill with gas at a high pressure. If this happens, it creates a dangerous situation when the user once again comes to withdraw gas and connects to the reservoir by opening the isolating valve.

To address this problem it is known practice to use safety vent valves which release gas in the event of overpressure or in the event of excessive temperature. However, even though the leaks are relatively small, in certain situations these known vent valves may also create dangerous situations by suddenly releasing a significant amount of gas. This is particularly hazardous when the gas is flammable, such as hydrogen.

One object of the present invention is to alleviate all or some of the abovementioned disadvantages of the prior art.

To this end, the device according to the invention, in a wider respect in accordance with the definition given thereof in the above preamble, is essentially characterized in that the valve is designed to close the discharge passage when the pressure in the low-pressure chamber is below a first threshold, to open the discharge passage when the pressure in the chamber is above the first pressure threshold and below a second pressure threshold and to close the discharge passage when the pressure in the chamber is above the second pressure threshold, the safety relief valve being designed to close the discharge passage when the pressure in the low-pressure chamber is below a first threshold, to open the discharge passage when the pressure in the chamber is above the first pressure threshold and below a second pressure threshold and to close the discharge passage when the pressure in the chamber is above the second pressure threshold.

Moreover, some embodiments of the invention may include one or more of the following features:
the safety relief valve comprises a moving shutter subjected to the pressure in the low-pressure chamber and urged by a return member toward a first position of closing the passage, said return means and the shutter being sized to allow the shutter to move between the first position of closing the discharge passage when the pressure in the low-pressure chamber is below the first pressure threshold, a second position of opening the discharge passage when the pressure in the chamber is above the first pressure threshold and below the second pressure threshold and a third position of closing the discharge passage when the pressure in the chamber is above the second pressure threshold,
the moving shutter comprises a piston coupled to a pressure relief valve of the pressure regulator and at least one seal able to collaborate for the purposes of closing/opening with the discharge passage,
the return member that returns the shutter comprises a spring the spring load of which is transmitted to the valve of the pressure regulator,
the return member for returning the shutter is situated in a volume subjected to the pressure outside the device, said volume preferably being connected to the outside via the gas discharge passage, downstream of the shutter,
the discharge passage comprises a groove formed between the shutter and the body of the device, the groove communicating fluidly firstly with the discharge passage and secondly with the low-pressure chamber, the shutter comprising a set of seals for keeping the discharge passage between the piston and the body of the device open or closed according to the position of the shutter with respect to the body and to the groove,
the shutter comprises a duct passing through it to place the low-pressure chamber in fluidic communication with the groove,
the shutter is capable of translational movement,
the low-pressure chamber is connected to the discharge passage via a restricting element that restricts the flow of gas to a determined value,
the device comprises a filling circuit distinct from the withdrawing circuit, the filling circuit having a first end connected to the reservoir directly or via the withdrawing circuit, upstream of the pressure regulator, and a second end distinct from the withdrawing circuit,
the first pressure threshold ranges between 20 and 29 bar and preferably between 23 and 25 bar,
the second pressure threshold ranges between 30 and 50 bar and preferably between 30 and 35 bar,
the determined value of gas flow rate as set by the restricting element ranges between 10 and 800 cm³/min and preferably between 10 and 50 cm³/min,
the duct in the shutter places the low-pressure chamber in fluidic communication with the groove via the restricting element.

Another object is to propose an assembly comprising a pressurized gas reservoir and a filling and distributing device according to any one of the features described hereinabove or hereinafter.

It is another object to propose a method of controlling natural leakages of gas leaks from a pressurized gas reservoir comprising a filling and dispensing device according to any one of the features described hereinabove or hereinbelow, in which steps of successively and automatically, via the safety relief valve, purging the gas which accumulates in the low-pressure chamber as a result of natural leakage are carried out in order to avoid an excessive pressure buildup and, if the pressure regulator fails and there is a sudden buildup of pressure in the low-pressure chamber, a step of automatically closing the safety relief valve is carried out.

The invention may also relate to any alternative method or device that contains any combination of the features listed hereinabove or hereinbelow.

Other particulars and advantages will become apparent from reading the description given hereinafter, with reference to the figures in which:

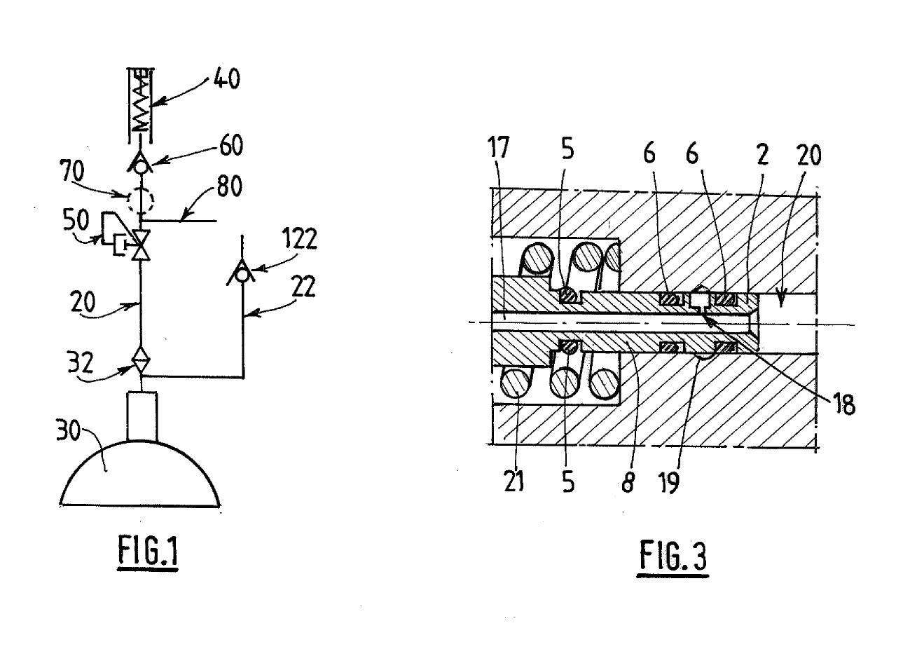

FIG. 1 is a schematic and partial view illustrating a pressurized gas reservoir provided with one example of a gas filling and distributing device according to the invention,

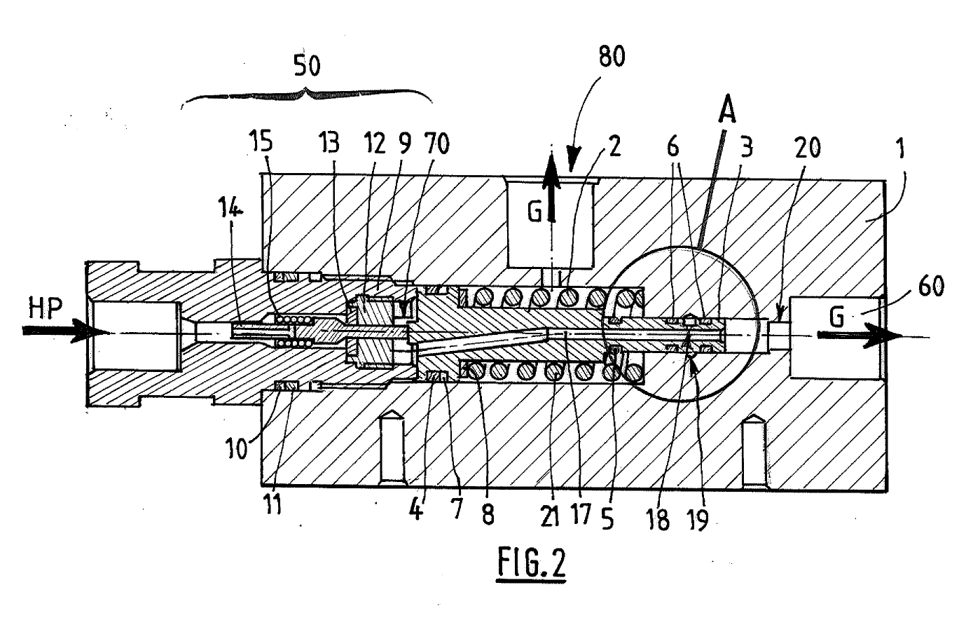

FIG. 2 is a partial and schematic cross section of a detail of one example of a gas filling and distributing device according to the invention, in a sequence of operation said to be “at rest”,

FIG. 3 is an enlargement of detail A of FIG. 2,

FIG. 4 is an enlargement of detail A of FIG. 2, in a sequence of operation known as “purging leakage gas to the outside”,

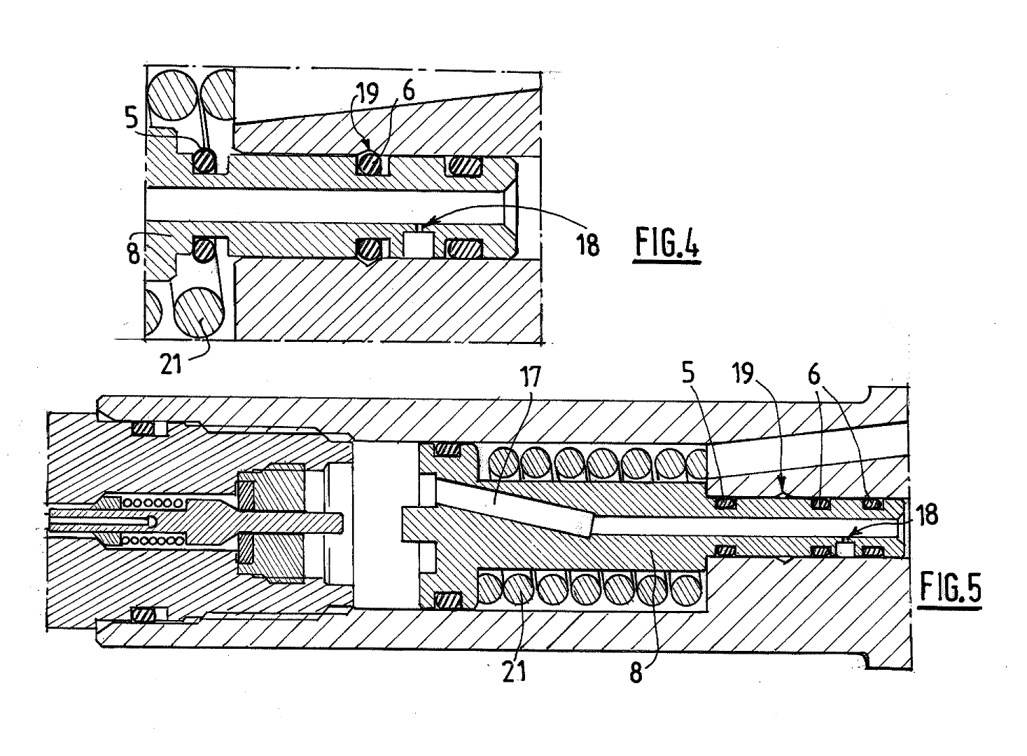

FIG. 5 is a partial view of the device of FIG. 2 including detail A in a sequence of operation known as “closure in the event of massive leak”.

The invention will now be described with reference to FIGS. 1 to 5 which illustrate one entirely nonlimiting example of an application thereof. In particular the invention can equally well be applied to any other type of device or valve. The invention may notably be applied to the devices described notably in documents WO2007/048954 A1 or WO2007/048957.

In the example of FIG. 1, the device or valve is mounted in the orifice of a pressurized gas cylinder 30. This device therefore comprises a body 1 (made in one or several parts) housing a gas withdrawing circuit 20 running between an upstream first end connected to the inside of the reservoir 30 and a downstream second end intended to be connected to a user 40 of the gas.

The withdrawal circuit 2 comprises, from the upstream to downstream end (from the first end to the second end): a filter 32 (optional), a pressure regulator 50, a low-pressure chamber 70 and an isolating valve 60. Downstream of the isolating valve 60 the device may comprise a quick coupling system intended to engage, for example, with a connector of a system 40 for withdrawing and for opening the isolating valve 60.

Between the low-pressure chamber 70 and an isolating valve 60 there is a safety gas outlet channel 80. Furthermore, a filling circuit 22 equipped with a shutter valve 22 is provided. With preference, at least part of the filling circuit 22 (for example the inlet) is independent of the withdrawing circuit 20.

FIG. 2 illustrates one example of an arrangement of the pressure regulator 50 subjected to the high pressure HP. As depicted, the pressure regulator 50 may be housed in a cartridge 9 that is added on (for example screwed on) to the body 1 in a sealed manner (seal 11, anti-creep ring 10). The pressure regulator 50 may comprise a valve 14 subject to the force of a spring 15 in the downstream direction towards a seat 13, 12. The downstream end of the valve 14 is for its part urged in the upstream direction by an antagonistic piston 8 sliding fluidtightly (seal 4, anti-creep ring 7) in the body 1 and urged via a piston spring 21.

The spring weights of the springs 15 and 21 of the valves 14 and pistons 8 ensure that the pressure regulator opens at a set pressure-relief pressure higher than atmospheric pressure.

The spring 21 which urges the piston 8 is connected to the external atmospheric pressure via a passage 80 to prevent any backpressure on the valve of the pressure regulator 50. The low-pressure chamber 70 is formed between the downstream end of the valve seat 12 and the upstream end of the piston 8.

The piston 8 has passing through it a duct 17 which places the low-pressure chamber 70 in fluidic communication with a groove 19 formed in the body 1 around the downstream end of the piston.

More specifically, a flow restricting element 18 formed in the body of the piston 8 sets the flow rate of the gas being carried in the region of a chamber situated in the region of the groove 19.

Under normal situations, the regulated gas from the low-pressure chamber 70 is halted at this point by a pair of O-ring seals 6 carried by the piston 8 and situated one on each side of the groove 19 (sealing against the body 1, FIGS. 2 and 3).

Downstream of the piston 8, the body 1 comprises the isolating valve 60 (not depicted in detail). Under normal situations of use during withdrawing, the regulated gas G emerges along this route (arrow to the right in FIG. 2).

If the regulator 50 leaks to a small extent, the pressure in the chamber 70 will gradually increase above the regulated pressure of the regulator 50. This will increase the force on the upstream face of the piston 8. This increasing pressure moves the piston 8 in the downstream direction (compressing the piston spring 21). When the pressure in the chamber 70 reaches a set first threshold, the upstream seal 6 of the pair of seals reaches the groove 19 and becomes lodged therein (FIG. 4). In this position, sealing between the body 1 and the piston 8 is no longer afforded upstream of the groove 19. The gas coming from the low-pressure chamber 70 via the restricting element 18 can flow and escape to the outside via the chamber of the piston spring 21 and the discharge passage 80 (valve open, arrow pointing up in FIG. 2).

When this determined amount of leakage gas has been released, the pressure in the low-pressure chamber 70 returns to its normal value and the piston 8 is pushed back in the upstream direction by its spring 21 to the position of FIGS. 2 and 3 in which the gas from the low-pressure chamber 70 cannot reach the discharge passage 80 (valve closed).

This process of gradual increase in pressure followed by a purge will be repeated automatically as long as a measured leakage occurs. In this way, small amounts of gas are released on each purge cycle. Thus, a small gas leak will not give rise to a disproportionate buildup of pressure in the device.

By contrast, in the event of a more significant increase in pressure in the low-pressure chamber, increasing beyond a second set pressure threshold (for example in the event of the regulator 50 failing), the piston 8 is pushed back by the gas in the downstream direction beyond the purge position of FIG. 4, to arrive in a closed position illustrated in FIG. 5. What actually happens is that the flow rate of gas arriving in the low-pressure chamber 70 exceeds the flow rate that can be discharged via the restricting element 18.

In this closed position, the pair of seals 6 has overstepped the groove 19 but an upstream seal 5 carried by the piston 8 will press against the body 1 and close off the gas passage between the outlet 80 and the groove 19. In addition, in this position, the pair of seals 6 once again fluidtightly flanks the restricting element 18 of the piston 8. In this closed position, the safety relief valve closes to prevent too much gas from being discharged via the discharge passage 80. The high-pressure gas which has passed through the defective pressure regulator 50 is held in the body via the isolating valve 6 and will be managed via the withdrawing tapping that may be provided for that purpose.

Likewise a system (a display) may signal the fact that the pressure on the outlet side of the isolating valve 60 is higher than the expected value.

1-12. (canceled)

13. A gas filling and dispensing device comprising
a) a body intended to be placed in an orifice of a pressurized gas storage reservoir,
b) a gas withdrawing circuit running between an upstream first end adapted for operable fluid connection to the inside of the pressurized gas storage reservoir and,
c) a downstream second end adapted for operable fluid connection to a recipient gas container,
wherein the withdrawing circuit comprises
a) a pressure regulator,
b) a low-pressure chamber and,
c) an isolating valve,
arranged in sequential series a)-c) from the upstream first end to the downstream second end,
the low-pressure chamber in operable fluid connection to a passage in operable fluid connection to the outside of the device via a safety relief valve,
wherein the safety relief valve is adapted to
a) close the discharge passage when the pressure in the low-pressure chamber is below a first threshold,
b) open the discharge passage when the pressure in the chamber is above the first pressure threshold and below a second pressure threshold, and
c) close the discharge passage when the pressure in the chamber is above the second pressure threshold.

14. The device of claim 13, wherein the safety relief valve comprises a moving shutter pressure from the gas in the low-pressure chamber and operably connected to a return member adapted to bias the shutter toward a first position of closing the passage, wherein the return member and the shutter are configured so that the shutter is capable of moving between the first position of closing the discharge passage when the pressure in the low-pressure chamber is below the first pressure threshold, a second position of opening the discharge passage when the pressure in the chamber is above the first pressure threshold and below the second pressure threshold and a third position of closing the discharge passage when the pressure in the chamber is above the second pressure threshold.

15. The device of claim 14, wherein the shutter comprises a piston coupled to a pressure relief valve of the pressure regulator and at least one cooperating seal, wherein the piston and the seal are capable of closing and opening the discharge passage.

16. The device of claim 15, wherein the return member comprises a spring operably connected to the return member to transmit a spring load to the valve of the pressure regulator.

17. The device of claim 14, wherein the return member is situated in a volume subjected to a pressure outside the device.

18. The device of claim 13, wherein the discharge passage comprises a groove formed between the shutter and the body of the device, the groove communicating fluidly firstly with the discharge passage and secondly with the low-pressure chamber, the shutter comprising a set of seals configured to keep the discharge passage between the piston and the body of the device open or closed according to the position of the shutter with respect to the body and to the groove.

19. The device of claim 18, wherein the shutter comprises a duct passing through the shutter to place the low-pressure chamber in fluidic communication with the groove.

20. The device of claim 13, wherein the shutter is capable of translational movement.

21. The device of claim 13, wherein the low-pressure chamber is connected to the discharge passage via a restricting element adapted to restrict the flow rate of the gas to a determined value.

22. The device of claim 13, wherein it comprises a filling circuit distinct from the withdrawing circuit, the filling circuit having a first end connected to the reservoir directly or via the withdrawing circuit, upstream of the pressure regulator, and a second end distinct from the withdrawing circuit.

23. An assembly comprising a pressurized gas reservoir and a filling and dispensing device of claim 13.

24. A method of controlling leakages of gas from a pressurized gas reservoir comprising, the steps of:
a) connecting the filling and dispensing device of claim 13 to the pressurized gas reservoir,
b) successively and automatically, via the safety relief valve, purging the gas which has built up in the low-pressure chamber as a result of natural leakage, in order to avoid an excessive pressure buildup and,
c) if the pressure regulator fails and there is a sudden buildup of pressure in the low-pressure chamber, a step of automatically closing the safety relief valve.
